(19) United States
(12) Patent Application Publication
(10) Pub. No.: US 2002/0154423 A1
(43) Pub. Date: Oct. 24, 2002

(54) Reflective mirror structure comprised of a multiplicity of prisms

(76) Inventor: Hans-Erich Gubela SR., Renchen (DE)

Correspondence Address: COLLARD & ROE, P.C., 1077 Northern Boulevard, Roslyn, NY, 11576-1696, US

(21) Appl. No.: 10/125,838

(22) Filed: Apr. 19, 2002

(30) Foreign Application Priority Data
Apr. 20, 2001 (DE) 101 19 671.7

(51) Int. Cl. G02B 5/122

(52) U.S. Cl. 359/850; 359/529; 359/834

(57) ABSTRACT

A reflective mirror structure comprised of a multiplicity of microprisms whose smallest edge length is less than 2.1 mm, each microprism comprising three mirror facets, a first and second one of the mirror facets as well as a third one and the second mirror facet extending at right angles to each other, while the first and third mirror facets enclose an angle of greater than 90° with each other, and a base facet of the microprisms projected onto a plane forming an irregular hexagon.

### BACKGROUND OF THE INVENTION

1. Field of the Invention

The present invention relates to a reflective mirror structure comprised of a multiplicity of microprisms whose smallest edge has a length of less than 2.1 mm.

2. Description of the Prior Art

The reflection with planar mirrors requires a lot of work to obtain an accurate angular orientation of the beam to be reflected. It is known to reflect light beams by an arrangement of mirrors or prisms. However, great difficulties are encountered in the assembly of such mirrors or prisms on machines and in so mounting and rapidly orienting the mirrors or prisms that the desired orientation of the reflected light beams is obtained. Only a person who has tried to guide an invisible light beam generated by a sensor through several reflections can appreciate how difficult this is. It requires long hours of training and an adaptation phase of the human brain to assess the angles and beam paths from the position of an observer whose eyes are not in the path of the beam. These difficulties multiply when the machine vibrates in operation, such as a conveyor. In this case, the light beam dances around as a result of the vibration, and the path of the light beam, which is reflected several times in different directions, changes considerably. In most instances, one of the intended targets is not reached by the reflected beam.

A cube-shaped, light-reflective mirror system known in the measuring art as Perkin-Elmer-Pyramide has been named a Fullcube. It comprises a prism of three square mirrors enclosing right angles with each other to retro-reflect the light to its source. British patent No. 269,760 discloses tools for the manufacture of such prisms.

DE 44 10 994 discloses bodies and/or body parts prism reflector in band formation and/or tools for shaping such prism reflectors having Fullcube properties. Such parts may be readily assembled in the microstructure technique to form surfaces, and can be used in the manufacture of shaped bodies and specifically all sorts of reflective structures.

### SUMMARY OF THE INVENTION

It is an object of this invention to provide a reflective mirror structure to reflect a light beam coming from a light source to another spatial point while permitting a tolerance in the correctly angled orientation of the light source, so that the assembly and use of the reflective mirror structure is easier than with known planar or prismatic reflective mirrors.

The above and other objects are accomplished according to the invention with a reflective mirror structure comprised of a multiplicity of microprisms whose smallest edge length is less than 2.1 mm, each microprism comprising three mirror facets, a first and second one of the mirror facets as well as a third one and the second mirror facet extending at right angles to each other, while the first and third mirror facets enclose an angle of greater than 90° with each other, and a base of the microprism projected onto a plane forming an irregular hexagon. In one embodiment, the three mirror facets are rectangular.

This reflective mirror structure is particularly useful when a multiple reflection is required because its easy handling makes it possible to orient it for the light beam path of the light beam to be reflected. The structure solves many practical orientation problems and makes possible new uses in the arts of light sensing, laser sensing, laser path guidance, and safety techniques in traffic, which require the reflection of light, as well in clear technology for reflecting beams of elementary particles.

The reflective mirror structure of the present invention enables optical sensors to look behind edges and corners, to produce light grids, to fulfill measuring tasks in narrow spaces, such as pipes or ball bearings, to observe rotations and warps, and to monitor rooms with respect to fires or smoke to provide fire protection. In traffic, the structure may provide wide angle views by adding additional prisms. The structure also has the sensing ability to make even the smallest mechanical changes optically measurable. It can also be used for dividing or reflecting beams of elementary particles.

The reflective mirror structure of this invention is based on the known manufacture of prismatic reflectors. The prisms used in the invention come close to the prisms used in the known Fullcube. Other prism shapes are also known, such as the three-sided pyramide. However, an improvement of the Fullcube is preferred because it has substantially less scattering losses than the pyramide. The pyramidal prism is preferred when the mechanical manufacture requires very small prisms because pyramidal prism structures may be cut from a common flat plane while Fullcube prisms require the arrangement of a multiplicity of structural elements to produce large structured surfaces from a multiplicity of prisms. However, the manufacturing methods, and their various advantages and disadvantages, are well known to those skilled in the art, wherefore they need not be further elucidated.

The invention has benefitted from the experiences gained in the manufacture and use of Fullcube prisms. They have the advantage to receive incident light in a wide tolerance range of incident angles and to retro-reflect it substantially completely to the light source. The retro-reflection is produced by the mirror reflection on the three square surfaces of the Fullcube prism. This angular tolerance for the incident light is now used in most reflective light barriers. The assembly and orientation of the retro-reflector at a correct angle with respect to the transmitter/receiver system are simple and substantially errorless. Movements of the beam by vibration are tolerated in most instances in such Fullcube prisms. However, the use of such prisms as reflective elements in laser light sensors is very difficult because, if not artfully used, the laser will deliver information about its movement on the retro-reflector and information about the shape of the retro-reflector rather than about the space to be monitored between the transmitter/receiver and the retro-reflector mirror. DE 197 27 527 discloses a retro-reflector mirror for laser sensors, explains the differences between Fullcube and pyramidal prisms, and teaches what shape the beam of the laser sensor must have. By applying this teaching, it is possible to obtain the advantages of the Fullcube prism structure also for laser sensors, and it can also be used for the utilization of the reflective mirror structure of the present invention.

In contrast to the known retro-reflector prims and according to the invention, not all the mirror facets enclose a right angle with each other, as is necessary for retro-reflection. Rather and significantly, the angle enclosed between two of the facets is substantially greater than 90°. Such a prism could not function for retro-reflection because the incident beam is divided into three beams. If this prism is a glass body, further beams will be scattered but they need not be considered for now.

### BRIEF DESCRIPTION OF THE DRAWING

The above and other objects, advantages and features of this invention will become more apparent from the following detailed description of certain now preferred embodiments thereof, taken in conjunction with the accompanying drawing wherein

FIGS. 1 and 2 illustrate two embodiments of a prism used in the reflective mirror structure of the invention;

FIG. 3 is a perspective view of a reflective mirror structure comprised of prisms according to FIG. 1;

FIG. 4 is a top view of FIG. 3;

FIG. 5 is an end view of FIG. 4;

FIG. 6 is a schematic top view of a modification of the reflective mirror structure of FIGS. 1 to 5;

FIG. 7 is a perspective view of a reflective mirror structure comprised of prisms according to FIG. 2;

FIG. 8 is a top view of FIG. 7;

FIG. 9 is an end view of FIG. 8;

FIG. 10 is a schematic top view of a modification of the reflective mirror structure of FIGS. 6 to 9;

FIGS. 11 and 12 show the light beam paths;

FIGS. 13 to 20 show some practical applications of the reflective mirror structure oriented in one direction, using an assembly of the prisms of FIG. 2 because the light paths produced by this embodiment are easier to illustrate.

### DETAILED DESCRIPTION OF THE PREFERRED EMBODIMENTS

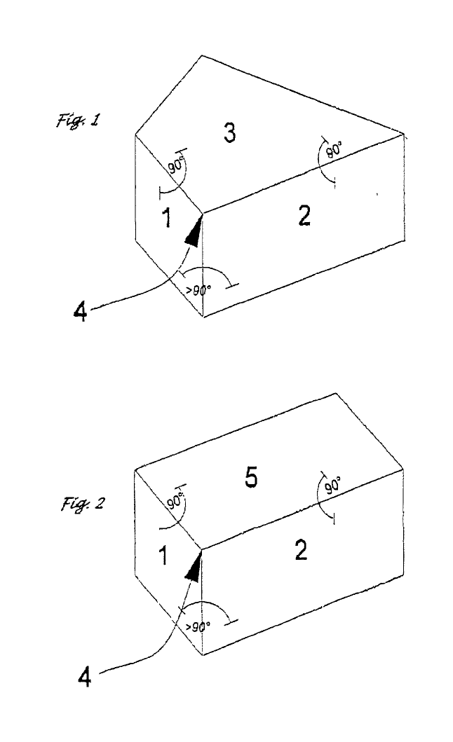

Referring now to the drawing, FIG. 1 shows a microprism comprising three mirror facets 1, 2 and 3, a first and second one of the mirror facets 1, 3 as well as a third one and the second mirror facet 2, 3 extending at right angles to each other, while the first and third mirror facets 1, 2 enclose an angle of greater than 90° with each other, and a base of the microprism projected onto a plane forming an irregular hexagon. Center 4 common to all three mirror facets is the deepest point of the prism. As shown, mirror facet 2 is an irregular quadrangle. Such microprims may be assembled with each other into a reflective mirror structure as shown in FIGS. 3 and 4, which may reflect the incident light into two different directions and operates like a beam divider.

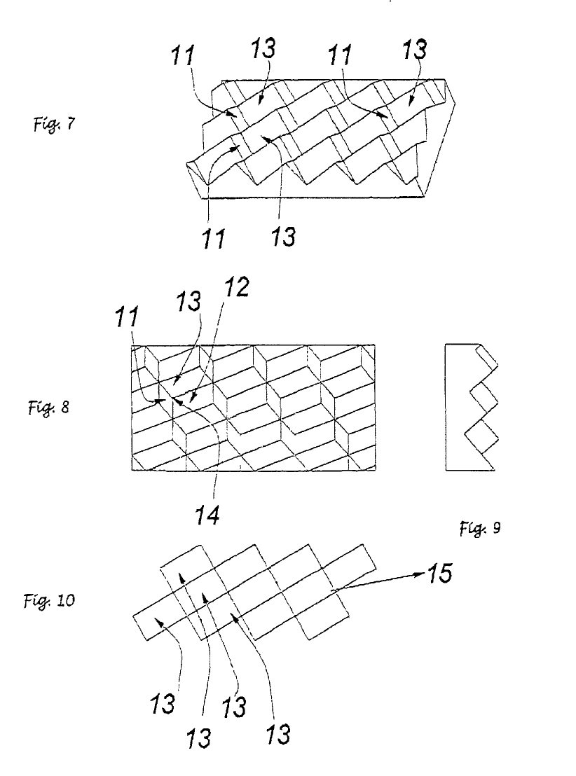

FIG. 2 illustrates an embodiment of the invention differing from that of FIG. 1 in that mirror facets 1, 2 and 5 are rectangular, mirror facets 1, 5 as well as a third one and the second mirror facet 2, 5 extending at right angles to each other, while the first and third mirror facets 1, 2 enclose an angle of greater than 90° with each other. Such microprims may be assembled with each other into a reflective mirror structure as shown in FIGS. 7 and 8, which may reflect the incident light substantially into a single direction.

Since mirror facet 2 has been turned about a common edge with respect to mirror facet 1, it is stretched. Stretching of mirror facet 2 means that there is more mirror surface available on which there are reference points for the beam paths coming from the two other mirror facets. As the beam paths are reflected, more receiving surface with possible reference points for the beam paths coming from the other mirror facets is available if the incident light beams first are incident on mirror facet 2.

To enable the microprisms to be seamlessly assembled and the light reception may be as great as possible, mirror facets 3 and 5 are larger than a square. In this way, the intensities of the three light beams reflected by the microprisms differ substantially from each other.

Thus, two fundamental functions may be distinguished:

(1) A reflective mirror structure assembly of microprisms of FIG. 1 reflects the incident light beam into two directions and, as shown in FIG. 20, substantially no light is lost.

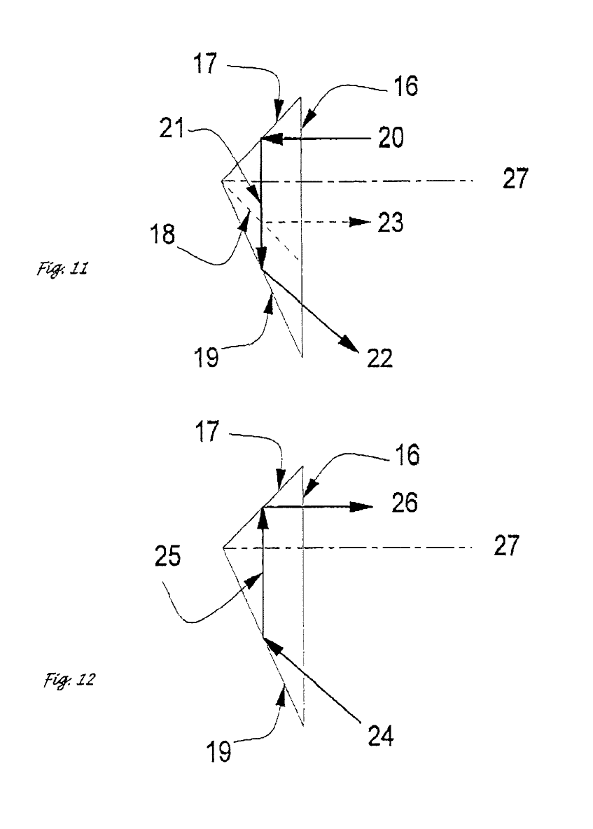

(2) A reflective mirror structure assembly of microprisms of FIG. 2 reflects the incident light beam into one direction, as shown in FIGS. 11 and 12.

Because of its tolerance with respect to the angle of the incident light beam, the reflective mirror structure is very easy to handle and to be manufactured for the desired reflected beam path. If mirror facet 2 is turned only 8° so that it encloses an angle of 98° with mirror facet 1, the reflective mirror structure will already produce a reflective angle of about 30° to 35° with respect to the angle of the incident light beam. The obtainable reflective angles depend on the material of the microprisms and the surface of the reflective mirror structure.

Each microprism may be an optical glass body, for example of borosilicate glass or quartz glass, or a body of a light-transparent synthetic resin, for example polymethylmethacrylate, polyvinylchloride and polycarbonate, or a body of a metal reflecting light of elementary particles, or a carrier body of glass, synthetic resin or metal, the carrier body having a surface layer of a metal reflecting light of elementary particles. The metal may be, for example, gold, silver, aluminum, nickel, brass, copper, bronze, nickel silver, titanium, lead and steel.

The reflective properties of microprism bodies of the above-described types differ relatively little, i.e. by about +/−7°. The differences in light loss, which depends on the materials used for the microprisms, does not interfere with the handling tolerance of such reflective mirror structures. The novel configuration of the microprisms opens wide-ranging possibilities, particularly in connection with optical sensors.

The reflective mirror structures shown in FIGS. 3 to 6 are assemblies of the microprism illustrated in FIG. 1. Mirror facets 2 and 7 of FIG. 4 are not visible in the perspective view of FIG. 3. Mirror facets 1 and 3 show the microprisms of a first orientation while mirror facets 6 and 8 show the microprisms of a second orientation, rotated by 180° with respect to the first orientation. The microprisms of the same orientation are arranged in a row, and the rows with microprisms of the two different orientation alternate. The orientation of the microprism determines the direction in which it reflects the incident light beam or from which it receives the incident light beam (see FIGS. 11 and 12).

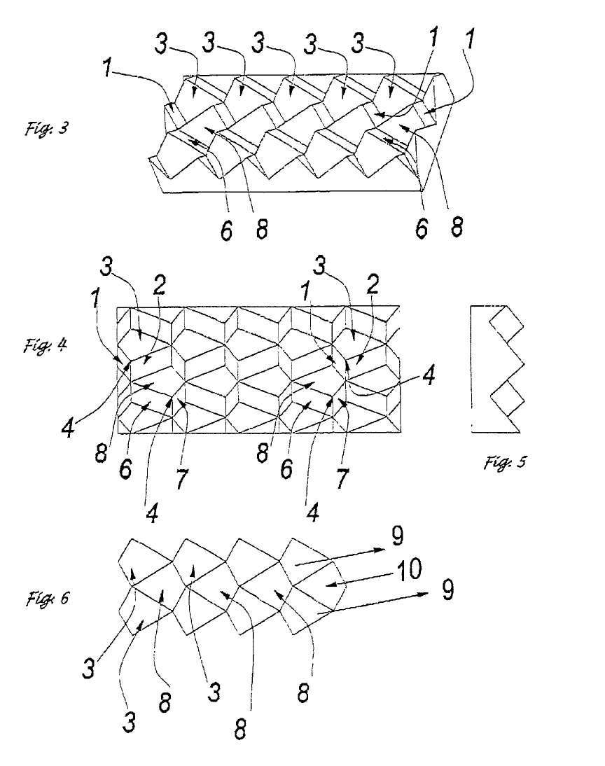

The top view of FIG. 4 illustrates the projection of all edges on a base. Mirror facets 1, 2, 3 extending from center 4 form the microprism of the first orientation (9 in FIG. 6). Mirror facets 6, 7, 8 extending from center 4 form the microprism of the second orientation (10 in FIG. 6). The section of FIG. 5 shows the oppositely directed rows of FIG. 4. The reflective mirror structure shown in FIG. 6 is so rotated that all mirror facets 3 of first orientation 9 form a closed reflecting surface with mirror facets 8 of second orientation 10. As shown, the microprisms are seamlessly assembled in the reflective mirror structure.

The reflective mirror structures shown in FIGS. 7 to 10 are assemblies of the microprism illustrated in FIG. 2. Mirror facet 12 of FIG. 8 is not visible in the perspective view of FIG. 7. The top view of FIG. 8 illustrates the projection of all edges on a base. All mirror facets 11, 12, 13 extending from center 14 form the microprism and the microprisms are oriented in the same direction so that the light is reflected substantially in one direction. The section of FIG. 9 shows unidirected rows of FIG. 8. The reflective mirror structure shown in FIG. 10 is so rotated that all mirror facets 13 of the same orientation 15 form a closed reflecting surface.

FIGS. 11 and 12 illustrate the light paths. When the incident light beam 20 (FIG. 11) is perpendicular, the major part of the light beam is reflected in direction 22. When the incident light beam 24 (FIG. 12) is inclined, the major part of the light beam is reflected in a perpendicular direction 26. The lost part of the light beam participates only a little in the desired reflection, most of it being reflected in an opposite direction, indicated by perpendicular 27. In this structure, some light is lost but, on the other hand, angle tolerance is gained for two different incident angles, as shown by incident beams 20 and 24.

It must be mentioned that the axis position of the microprism with respect to the light incident plane may be varied so that the light paths for the reflection may be changed for the angle of the incident beam as well as the angle of the reflected beam. The effect of the reflective mirror structure is further enhanced by the use of microprims whose smallest edge has a length of less than 2.1 mm. Such microprisms exhibit greater beam angle tolerances than known macroprisms. The high precision of microstructure manufacturing methods may be used for producing such microprisms, and these microprisms produce a much higher light recovery than macroprisms.

FIGS. 11 and 12 illustrate the operating principle of the reflective mirror structure, and FIG. 11 shows a comparison with a retro-reflector. The microprism is shown simplified as a two-dimensional glass body with greatly exaggerated beam angles so as to make the operation clearer. In actual operation, even minor variations in the angle have a great effect, but this is difficult to illustrate. The optical glass body has an optical axis which, in the illustrated embodiment, coincides with the perpendicular 27 on light incidence side 16. When the microprism is turned with respect to light incidence side 16, the optical axis will not be coincident with perpendicular 27.

Line 17 represents mirror facets 1 and 3 of the embodiment of FIG. 1 and mirror facets 1 and 5 of the embodiment of FIG. 2, i.e. mirror facets enclosing a right angle with each other. Dashed line 18 represents a third mirror facet enclosing a right angle with each one of the other two mirror facets, as would be the case in a retro-reflector, which would retro-reflect incident beam 20 in the direction of arrow 23 back to the light source. Retro-reflected beam 23 is displaced from incident beam 20, the extent of the displacement depending on the size of the retro-reflecting prism.

According to the invention, retro-reflecting mirror facet 18 is replaced by mirror facet 19 corresponding to mirror facet 2 in the embodiments shown in FIGS. 1 and 2. In other words, mirror facet 18 is rotated about an axis defined by the common edge of mirror facets 1 and 2, and the rectangle of mirror facet 2 is stretched so that the angle between mirror facets 1 and 2 is larger than 90°. The rotated mirror facet is designated 19. In FIG. 11, incident beam 20 is first reflected as beam 21, and is then reflected from the microprism as beam 22. It is not returned to the light source.

In FIG. 12, the same microprism is shown reflecting inclined incident light beam 24 first as beam 25 and then as perpendicularly reflected beam 26.

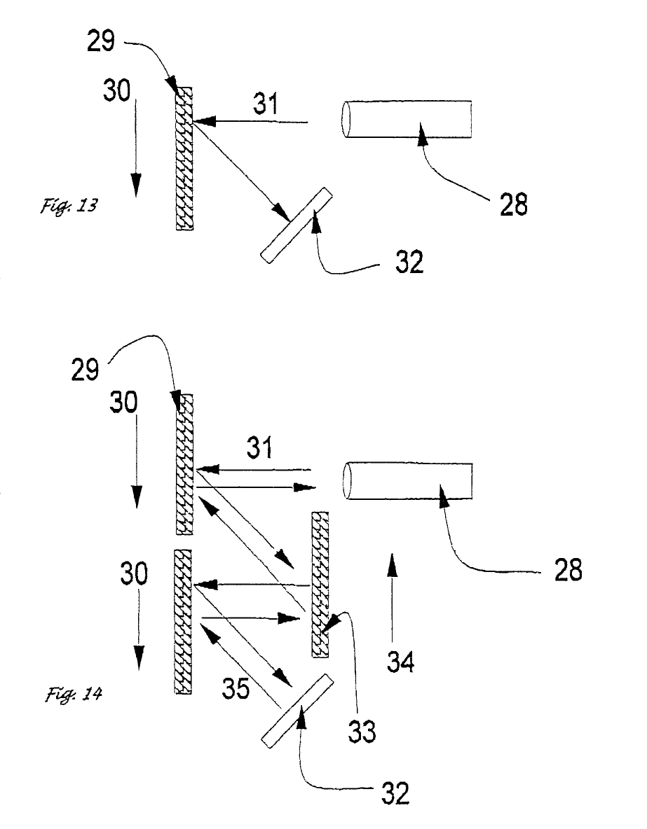

In FIGS. 13 to 16, reference numeral 28 indicates a transmitter of a beam 31, which may be a light beam, a laser beam or a beam of elementary particles, and which is reflected by reflective mirror structure 29 to receiver 32. Reflective mirror structure 29 is oriented in direction 30, and receiver 32 may process the reflected beam in any desired manner, functioning as a light barrier, for example.

The receiver may also be a retro-reflector which retro-reflects the beam along the same path back to the transmitter. In this case, the transmitter becomes also the receiver, as is the case in a light reflector barrier. FIG. 14 illustrates how beam 31 is retro-reflected as beam 35. Beam 31 is retro-reflected several times by facing reflective mirror structures 29, 33, which are oriented in opposite directions 30, 34, thus producing a light grid between reflective mirror structures 29 and 33. Such a light grid may, for example, monitor on a synthetic resin injection molding machine whether a synthetic resin parts falls through. It may also form a light grid in a safety monitoring, with little electronic cost. This could be done heretofore only with an expensive arrangement of many light barriers.

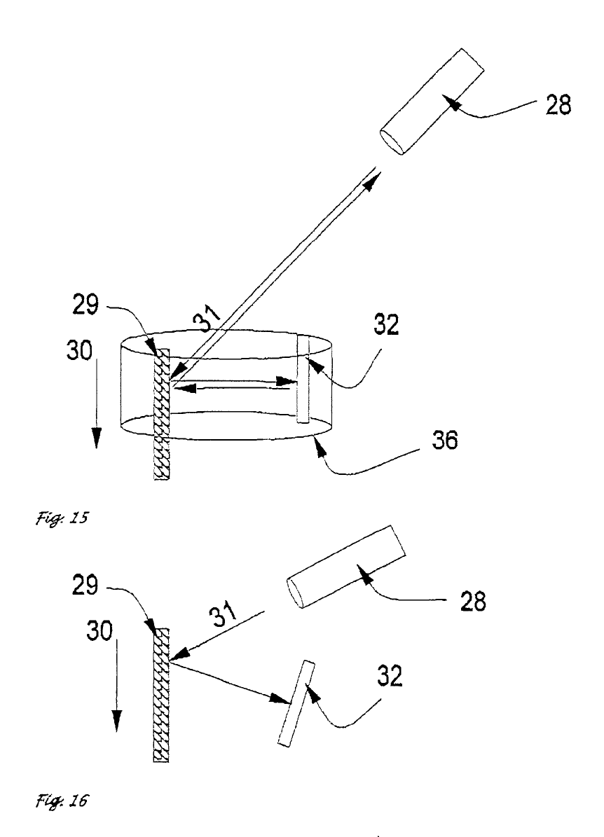

FIG. 15 illustrates a particular monitoring system for use of a light barrier or any optical measuring system. Often, there is no room on machines to mount light barriers. In the textile industry, for example, there is a problem in looking with a light beam behind the spools in order to monitor yarn breaks. The reflective mirror structure of this invention solves this problem. As shown, it makes it possible to monitor the interior of a tube 36 with it. Transducer 28 transmits beam 31 to reflective mirror structure 29, which retro-reflects it to retro-reflector 32 to be returned in the same path to transducer 28 arranged outside tube 36.

If reflectors 29 and 32 are metal or borosilicate glass bodies, they may monitor a high-temperature area of 500° C., for instance, from a distance. FIG. 15 also shows an application to a particularly difficult measuring task. For example, if the rotation or warp within a ball bearing is to be monitored, the measuring electronic system may be positioned outside the ball bearing while reflective mirror structures 29 and 32 are arranged within the ball bearing 36.

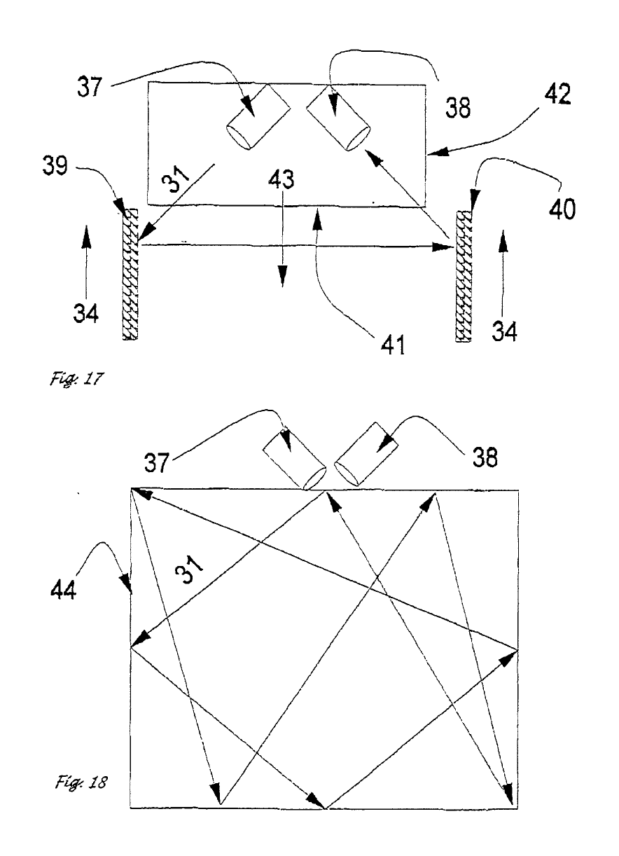

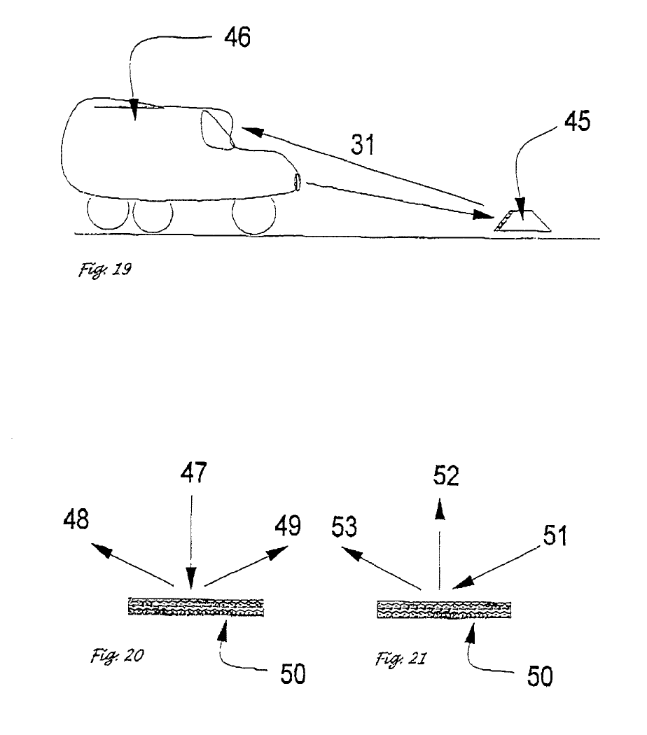

FIG. 16 shows that reflective mirror structure 29 may handle incident beam 31 at different angles, producing different angle of the reflected beam. For this purpose, the microprisms are so assembled that the axes of the microprisms are repositioned.

FIG. 17 illustrates an application particularly useful with rolling doors 42 closing in a downward movement in the direction of arrow 43. A single light barrier produced by transmitter 37 and receiver 38 monitors the entire width of the door. The light barrier system is mounted on the rolling door, and long bands 39, 40 comprised of reflective mirror structures according to the invention and oriented in direction 34 are arranged alongside the door. Light beam 31 coming from transmitter 37 is reflected by the reflective mirror structures to receiver 38 and forms a horizontal light barrier between bands 39 and 40 below edge 41 of the rolling door. The light barrier always remains below edge 41 as rolling door 42 descends in the direction of arrow 43 and monitors whether any object is in the way of the door movement so that the same may be electronically halted.

FIG. 18 illustrates the application of such a system as a smoke detector in a room 44. By arranging different reflective mirror structures on the walls of the room, whose differences are only in the angular positioning of mirror facet 2, the light paths between receiver 38 and receiver 37 may assume desired direction in the room.

FIG. 18 illustrates the application of such a system in traffic. Retro-reflecting markers 45 arranged on the road solve the problem of making the retro-reflected beam 31 of the headlights of a truck visible to the driver, who sits at an elevated position relative to the road. However, retro-reflectors return the light directly to the light source. However, if microprisms according to the invention are added to the prisms of the retro-reflecting markers 45, the light coming from the headlights can be reflected to a height of the eyes of the driver. In other words, the vertical range of the retro-reflection is widened.

FIG. 20 illustrates the functioning of the reflective mirror structure of FIG. 3, which is an assembly of the microprisms of FIG. 1. Incident beam 47 is divided into two reflected beam 48, 49 which leave reflective mirror structure 50 in opposite directions. This beam dividing effect makes it possible to construct very complex light barriers and monitoring systems. In the nuclear industry, where the structure of this invention may be used for reflecting elementary particle beams, the microprisms may be nickel or lead bodies.

In FIG. 21, reflective mirror structure 50 receives inclined incident beam 51 and reflects it in directions 52 and 53. In this case, the reflective mirror structure operates as a beam guide so that reflected beams 52 and 53 may be received by two different monitoring systems for processing.

If desired, a retro-reflector may be arranged in the path of any one of reflected beams 48, 49, 52, 53 so that the beams are retro-reflected to the transducer or are reinforced in one of the directions.

The reflective mirror structures of the present invention may cover large areas on shields, bands or foils. They may also be used in simpler applications in the lighting technique, for instance for background lighting of LCD-displays or for an improved distribution of light in a lighted room.

Experiments with reflective mirror structures incorporating the microprism of FIG. 2 in a simple optical sensor have shown that two reflections could be obtained very easily and angle-tolerant at a distance of about 9 meters to simulate the sensor arrangement for a large rolling door, as shown in FIG. 17. By using the microprisms a perfect reflection stability was obtained even when the incident beam was vibrated. There is every reason to assume that the reflective mirror structure of this invention will satisfactorily operate for monitoring at distances up to 100 meters. The experiments have shown other excellent properties of these structures. They are as tolerant with respect to the angle of the incident beam as Fullcube reflectors but they affect the angle of the reflected beam substantially when environmental factors, such as the temperature, are changed. For this reason, the reflective mirror structure of the invention is an excellent sensing element for signaling small changes, for instance in heat, impact, jamming, warping and all sorts of deformations. If mounted on rapidly rotating shafts in ship building, for example, all changes in the shaft may be readily monitored. This is derived from the angular position of the microprisms. Even a small change in the angle of mirror facet 3 with respect to mirror facet 1 has the effect of a multiplied reflection produced by the microprism. The property of the total system as a monitoring mirror is reinforced if the beam is reflected by a number of such reflective mirror systems.

What is claimed is:

1. A reflective mirror structure comprised of a multiplicity of microprisms whose smallest edge length is less than 2.1 mm, each microprism comprising three mirror facets, a first and second one of the mirror facets as well as a third one and the second mirror facet extending at right angles to each other, while the first and third mirror facets enclose an angle of greater than 90° with each other, and a base of the microprism projected onto a plane forming an irregular hexagon.

2. The reflective mirror structure of claim 1, wherein the three mirror facets are rectangular.

3. The reflective mirror structure of claim 2, wherein each microprism is an optical glass body.

3. The reflective mirror structure of claim 3, wherein the glass is selected from the group consisting of borosilicate glass and quartz glass.

4. The reflective mirror structure of claim 2, wherein each microprism is a body of a light-transparent synthetic resin.

5. The reflective mirror structure of claim 4, wherein the synthetic resin is selected from the group consisting of polymethylmethacrylate, polyvinylchloride and polycarbonate.

6. The reflective mirror structure of claim 2, wherein each microprism is a body of a metal reflecting light of elementary particles.

7. The reflective mirror structure of claim 6, wherein the metal is selected from the group consisting of gold, silver, aluminum, nickel, brass, copper, bronze, nickel silver, titanium, lead and steel.

8. The reflective mirror structure of claim 2, wherein each microprism is a carrier body of a substance selected from the group consisting of glass, synthetic resin or metal, and the carrier body has a surface layer of a metal reflecting light of elementary particles.

9. The reflective mirror structure of claim 8, wherein the surface layer metal is selected from the group consisting of gold, silver, aluminum, nickel, brass, copper, bronze, nickel silver, titanium, lead and steel.

10. The reflective mirror structure of claim 1, wherein the three mirror facets are rectangular.

11. The reflective mirror structure of claim 10, wherein each microprism is an optical glass body.

12. The reflective mirror structure of claim 11, wherein the glass is selected from the group consisting of borosilicate glass and quartz glass.

13. The reflective mirror structure of claim 1, wherein each microprism is a body of a light-transparent synthetic resin.

14. The reflective mirror structure of claim 13, wherein the synthetic resin is selected from the group consisting of polymethylmethacrylate, polyvinylchloride and polycarbonate.

15. The reflective mirror structure of claim 1, wherein each microprism is a body of a metal reflecting light of elementary particles.

16. The reflective mirror structure of claim 15, wherein the metal is selected from the group consisting of gold, silver, aluminum, nickel, brass, copper, bronze, nickel silver, titanium, lead and steel.

17. The reflective mirror structure of claim 1, wherein each microprism is a carrier body of a substance selected from the group consisting of glass, synthetic resin or metal, and the carrier body has a surface layer of a metal reflecting light of elementary particles.

18. The reflective mirror structure of claim 17, wherein the surface layer metal is selected from the group consisting of gold, silver, aluminum, nickel, brass, copper, bronze, nickel silver, titanium, lead and steel.
